(19) United States
(12) Patent Application Publication
(10) Pub. No.: US 2013/0265317 A1
(43) Pub. Date: Oct. 10, 2013

(54) DISPLAY SYSTEM OF ELECTRONIC DEVICE

(71) Applicant: CHIH-HUANG WU, New Taipei (TW)

(72) Inventor: CHIH-HUANG WU, New Taipei (TW)

(21) Appl. No.: 13/686,947

(22) Filed: Nov. 28, 2012

(30) Foreign Application Priority Data
Apr. 5, 2012 (TW) 101111977

(51) Int. Cl. G09G 5/399; G09G 5/36

(52) U.S. Cl. CPC G09G 5/399; G09G 5/363
USPC 345/501; 345/536

(57) ABSTRACT

A display system includes a main processor, a graphics card, and a display. The graphics card includes a plurality of video memory modules. When the display system displays a selected image, the main processor determines a display mode of the selected image according to inherent characteristics of an image file corresponding to the selected image, selects ones of the video memory modules in a desirable number to display the selected image, and controls selected ones of the video memory modules and the display to display the selected image according to the display mode.

### BACKGROUND

1. Technical Field

The present disclosure relates to display systems of electronic devices, and particularly to a display system that is capable of conserving power.

2. Description of Related Art

Many electronic devices such as personal computers, personal digital assistants, and mobile phones, for example, are capable of displaying not only images in two-dimensional (2D) modes but also images in three-dimensional (3D) modes. A display of such an electronic device may include video memory modules. Generally, displaying images in 2D modes uses less video memory modules, and displaying images in 3D modes uses more video memory modules.

However, in such an electronic device, according to related art, the video memory modules are usually turned on and off synchronously. When the electronic device displays any image, even if displaying the image does not need to use all of the video memory modules (e.g., when displaying an image in a 2D mode), all of the video memory modules will be turned on. Thus, electrical power of the electronic device may be wasted.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the various figures.

FIG. 1 is a schematic view of a display system, according to an exemplary embodiment.

FIG. 2 is a block diagram of the display system shown in FIG. 1.

### DETAILED DESCRIPTION

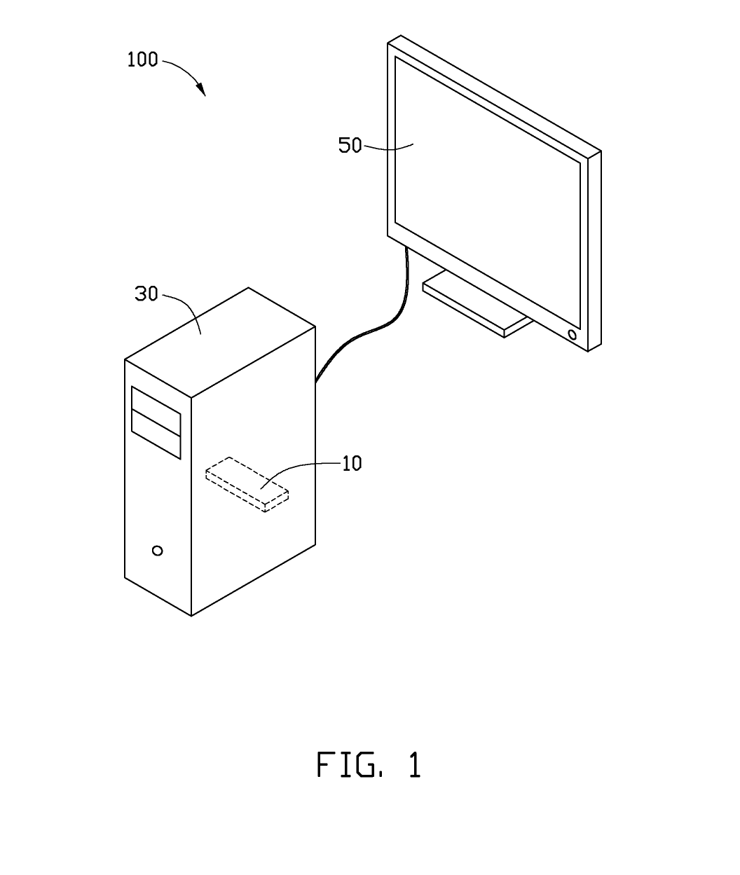

FIG. 1 is a schematic view of a display system 100 according to an exemplary embodiment. The display system 100 includes a graphics card 10, a main processor 30, and a display 50. The main processor 30 can be integrated within a common electronic device that is capable of processing data, for example, a personal computer (PC). The display 50 can be a screen. The graphics card 10 is electrically connected to both the main processor 30 and the display device 50. The graphics card 10 can transform image files provided by the main processor 30 into image signals, and send the image signals to the display device 50 to display images corresponding to the image files.

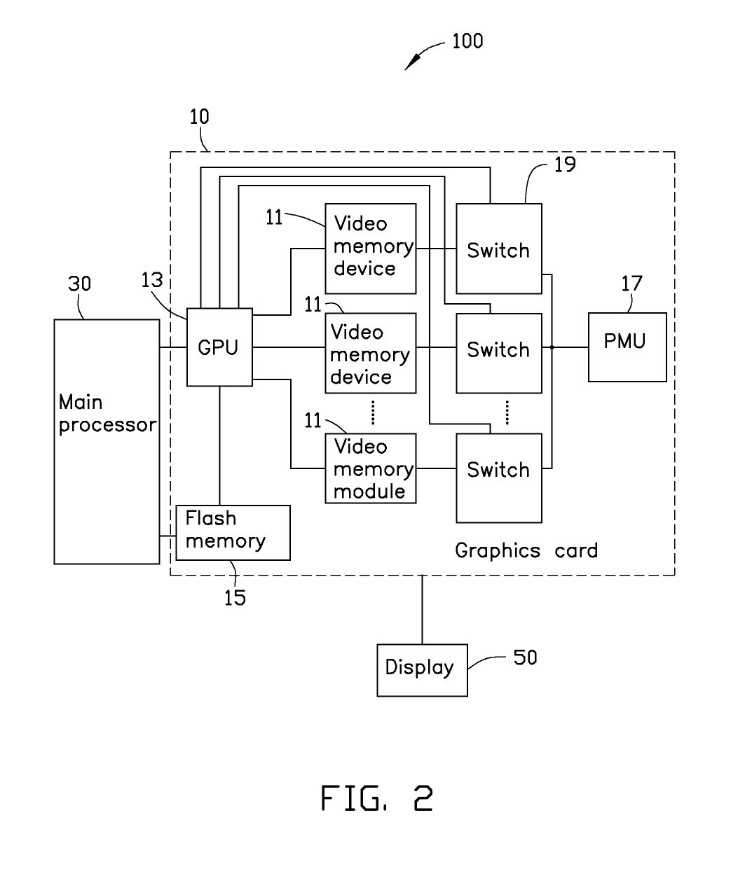

Also referring to FIG. 2, the graphics card 10 includes a plurality of video memory modules 11, a graphic processing unit (GPU) 13, a flash memory 15, a power management unit (PMU) 17, and a plurality of switches 19 corresponding to the video memory modules 11. The video memory modules 11 and the flash memory 15 are all electrically connected to the GPU 13. Both the GPU 13 and the flash memory 15 are electrically connected to the main processor 30. Each of the video memory modules 11 is electrically connected to the PMU 17 via a corresponding one of the switches 19, such that the PMU 17 can supply electrical power to each of the video memory modules 11 via the switch 19 corresponding to each of the video memory modules 11. Furthermore, each of the plurality of switches 19 is electrically connected to the GPU 13, and the GPU 13 can control each of the switches 19 to be turned on and off.

When the display system 100 displays a selected image, the main processor 30 finds an image file corresponding to the selected image in common storage devices (e.g., hard disk drives) of the electronic device employing the display system 100, and determines a suitable display mode of the selected image according to inherent characteristics of the image file (e.g., a file type, a size, a resolution, and colors, etc.). Upon determining the suitable display mode of the selected image, the main processor 30 sends display mode indication information corresponding to the selected image to the flash memory 15. The GPU 13 reads the display mode indication information to be informed of the suitable display mode of the selected image, and determines how many of the video memory modules 11 are required to display the selected image in the suitable display mode.

Once determining the desirable number of the video memory modules 11 to display the selected image, the GPU 13 selects ones of the video memory modules 11 in the desirable number to display the selected image, and controls selected ones of the switches 19 corresponding to the selected video memory modules 11 to be turned on. The video memory modules 11 corresponding to the turned-on switches 19 are electrically connected to the PMU 17, and are enabled to be turned on and to work. Thus, the GPU 13 controls the selected ones the video memory modules 11 in the desirable number to be turned on. The GPU 13 and the turned-on video memory modules 11 are then used to transform the image file corresponding to the selected image into image signals by conventional methods, and the image signals are transmitted to the display 50 to display. In this way, the main processor 30 can control the GPU 13, the selected ones of the video memory modules 11 in the desirable number, and the display 50 to display the selected image.

According to related art, if the suitable display mode of the selected image is a two-dimensional (2D) display mode, displaying the selected image needs less video memory modules 11. If the suitable display mode of the selected image is a three-dimensional (3D) display mode, displaying the selected image needs more video memory modules 11. In this embodiment, by the above-described method, the GPU 13 turns on less video memory modules 11 when the selected image needs to be displayed in a 2D display mode, and turns on more video memory modules 11 when the selected image needs to be displayed in a 3D display mode. In this way, the display system 100 can conserve electrical power when not all of the video memory modules 11 need to be used.

When a first displayed image is currently displayed by the display system 100 and a second selected image is to be displayed, the main processor 30 finds an image file corresponding to the second selected image, determines a suitable display mode of the second selected image according to inherent characteristics of the image file, and sends display mode indication information corresponding to the second selected image to the flash memory 15. The GPU 13 reads the display mode indication information corresponding to the second selected image to be informed of the suitable display mode of the selected image, and determines how many of the video memory modules 11 are required to display the second selected image in a suitable display mode. Thus, the GPU 13 can adjust the number of the turned-on video memory modules 11 to display the second selected image in the suitable display mode. In this way, the display system 100 can be used to play video files.

In another embodiment, when the main processor 30 sends display mode indication information corresponding to each selected image to the flash memory 15, if the flash memory 15 has stored display mode indication information corresponding to at least one previously displayed image, the main processor 30 uses the display mode indication information corresponding to the selected image to cover the mode indication information corresponding to the previous displayed image(s). Thus, the GPU 13 can easily find and read the display mode indication information corresponding to the selected image.

In another embodiment, when the switch 19 corresponding to each video memory module 11 is turned on and electrically connects the video memory module 11 to the PMU 17, the GPU 13 can directly turn on and off each video memory module 11, without operating the switch 19 corresponding to each video memory module 11.

In another embodiment, when the display system 100 displays images in display modes that do not need to use many video memory modules 11 (e.g., when displaying images in most 2D display modes), a core clock frequency and/or a memory clock frequency of the GPU 13 is decreased by the GPU 13 itself or the main processor 30, so that electrical power is further conserved.

It is to be further understood that even though numerous characteristics and advantages of the present embodiments have been set forth in the foregoing description, together with details of structures and functions of various embodiments, the disclosure is illustrative only, and changes may be made in detail, especially in matters of arrangement of parts within the principles of the present invention to the full extent indicated by the broad general meaning of the terms in which the appended claims are expressed.

What is claimed is:

1. A display system, comprising:
a main processor;
a graphics card electrically connected to the main processor and including a plurality of video memory modules; and
a display electrically connected to the graphics card;
wherein when the display system displays a selected image, the main processor determines a display mode of the selected image according to inherent characteristics of an image file corresponding to the selected image, selects ones of the video memory modules in a desirable number to display the selected image, and controls selected ones of the video memory modules and the display to display the selected image according to the display mode.

2. The display system of claim 1, wherein the graphics card further includes a graphics processing unit (GPU) electrically connected between the main processor and each of the plurality of video memory modules, and the main processor controls the selected ones of the video memory modules via the GPU.

3. The display system of claim 2, wherein the graphics card further includes a flash memory electrically connected to both the main processor and the GPU; the main processor sends display mode indication information corresponding to the selected image to the flash memory, and the GPU reads the display mode indication information to be informed of the display mode of the selected image and determines how many of the video memory modules are required to display the selected image in the display mode.

4. The display system of claim 3, wherein the GPU controls selected ones of the video memory modules to be turned on according to the display mode, and the main processor controls the GPU and the turned-on video memory modules to display the selected image.

5. The display system of claim 4, wherein the graphics card further includes a power management unit (PMU), and the GPU controls each of the video memory modules to be electrically connected to and disconnected from the PMU to turn on and off each of the video memory modules.

6. The display system of claim 5, wherein the graphics card further includes a plurality of switches corresponding to the video memory modules; each of the video memory modules is electrically connected to the PMU via a corresponding one of the switches; each of the switches is further electrically connected to the GPU; and the GPU controls each of the switches to be turned on and off.

7. The display system of claim 6, wherein the GPU further controls each of the video memory modules to be turned on and off when the switch corresponding to the video memory module stays being turned on.

8. The display system of claim 3, wherein when the flash memory stores display mode indication information corresponding to at least one previously displayed image, the main processor uses the display mode indication information corresponding to the selected image to cover the mode indication information corresponding to the previous displayed image(s).

9. The display system of claim 2, wherein at least one of the main processor and the GPU decreases at least one of a core clock frequency of the GPU and a memory clock frequency of the GPU when the display system displays images in predetermined display modes.
